(19) United States
(12) Patent Application Publication
(10) Pub. No.: US 2018/0315987 A1
(43) Pub. Date: Nov. 1, 2018

(54) BATTERY SYSTEM FOR A VEHICLE

(71) Applicant: LITHIUM ENERGY AND POWER GMBH & CO.KG, Stuttgart (DE)

(72) Inventor: Marco Friedrich, Ludwigsburg (DE)

(21) Appl. No.: 15/774,041

(22) PCT Filed: Oct. 26, 2016
(86) PCT No.: PCT/EP2016/075822

§ 371 Date: May 7, 2018

(30) Foreign Application Priority Data
Nov. 5, 2015 (EP) 15193303.3

(51) Int. Cl. H01M 2/34; H01M 2/30; H01M 10/42; H01M 10/48; H01M 10/44; B60L 11/18

(52) U.S. Cl. CPC H01M 2/348; H01M 2/305; H01M 10/425; H01M 10/482; H01M 10/4235; H01M 2220/20; H01M 10/443; B60L 11/1864; H01M 2200/103; H01M 2010/4278; H01M 10/441

(57) ABSTRACT

The invention relates to a battery system (10) for a vehicle or for a stationary energy store, comprising a battery (20). A first of a plurality of battery cells (21, 22) of the battery (20) comprises an electrochemical part, which has a plurality of electrodes and at least one separator, which, upon reaching a first temperature, is impermeable to ions that can be produced in the electrochemical part. The first battery cell (21) comprises a quick discharge unit, which can be connected, by means of a control unit (30) of the battery system (10), between two battery cell terminals of the first battery cell (21), which battery cell terminals can be contacted from inside and/or outside of the first battery cell (21). The quick discharge unit is designed to discharge the first battery cell (21) by means of a first current. A first resistance value of the quick discharge unit is selected in such a way that, while the first current flows through the quick discharge unit and the first battery cell (21), the first current causes such heating of the electrochemical part that the at least one separator reaches the first temperature.

### BACKGROUND OF THE INVENTION

The present invention relates to a battery system for a vehicle. The battery system comprises a battery, which has a plurality of battery cells, and a control unit. A first of the battery cells comprises an electrochemical part comprising a plurality of electrodes and at least one separator. Upon reaching a first temperature, the at least one separator becomes at least partly impermeable to ions that can be generated in the electrochemical part. The invention further relates to a method for transferring the first battery cell to a safe state.

It is known from the prior art that there is an inherent hazard potential in battery cells designed in the form of primary or secondary electrochemical energy stores, such as lithium-ion battery cells, for example. An electrochemical energy store of this kind is disclosed, for example, in each of documents EP 1 856 749 B1, DE 10 2008 050 872 A1, DE 10 2012 023 294 A1, DE 10 2013 200 848 A1 and DE 10 2013 203 485 A1 and has an electrochemical part, which comprises a plurality of electrodes and at least one separator. The separator of the electrochemical energy store known from document EP 1 856 749 B1 comprises two layers, which, upon reaching different temperatures, each become impermeable to ions that can be generated in the electrochemical part of said electrochemical energy store.

Hazards caused specifically by the aforementioned battery cells can arise, for example, as a result of fault states of the battery cells. Such a fault state of a battery cell can arise as a result of a discharge current, which is caused by a short circuit and has a very high current value, of the battery cell. A current value of a current is understood here to mean a magnitude of said current. A fault state, described above, of a battery cell can further arise as a result of a thermal runaway of the battery cell caused by chemical processes taking place inside the battery cell. In the case of a lithium-ion battery cell, such chemical processes can be very highly exothermal chemical reactions. A thermal runaway of a battery cell is understood to mean very intense overheating of said battery cell, as a result of which a destruction of said battery cell caused by fire and/or explosion occurs.

It is further known from the prior art to combine a plurality of battery cells described above to form a battery and to use battery systems having batteries of this kind in hybrid and electric vehicles. Batteries of this kind often have to supply a high electrical power and can store a large amount of electrical energy. As a result thereof, said batteries have a high hazard potential. At the same time, however, there are high demands on the operational safety of a battery system having a battery of this kind that have to be taken into account during production of the battery system.

Potentially dangerous situations can occur, in particular, when a vehicle operated using a battery system described above is involved in an accident or is damaged or brought to a fault state in some other way as a result of a natural disaster, such as, for example, as a result of flooding of the vehicle. This can lead to damage of voltage-carrying parts present in the vehicle or of an insulating encasement of parts of this kind or of a battery of the battery system present in the vehicle. Instances of damage of this kind can lead both to hazards for vehicle occupants or other people located in the surroundings of the vehicle as well as to hazards for objects located in the surroundings of the vehicle. These hazards can arise, for example, as a result of fault currents, which are caused by the damaged battery. It should be taken into account here that fault currents of this kind can cause, for example, a hazard due to contact current and electric arcs and, in the presence of short circuits, also a hazard due to heat. Hazards of this kind can further arise as a result of energy stored electrochemically in the battery cells of the damaged battery as well. It should be taken into account here that said energy stored in this way can cause a hazard due to ignition or explosion of the battery cells of the damaged battery.

The hazards described above can also arise as a result of an improper use or an inappropriate opening or manipulations of a battery system described above. Such improper use may be an improper application of a battery system of this kind outside of its permitted field of application, which leads to values of operating parameters of the battery system that are respectively outside of a permitted value range.

### SUMMARY OF THE INVENTION

According to the invention, a battery system for a vehicle comprising a battery, which has a plurality of battery cells, and a control unit is provided. Here, a first of the battery cells comprises an electrochemical part comprising a plurality of electrodes and at least one separator. Here, upon reaching a first temperature, the at least one separator becomes at least partly impermeable to ions that can be generated in the electrochemical part. The first battery cell furthermore comprises a rapid-discharge unit. In this case, the rapid-discharge unit can be electrically connected, by means of the control unit, between two battery cell terminals of the first battery cell, which battery cell terminals can be contact-connected from inside and/or outside of the first battery cell. The rapid-discharge unit is further designed to discharge the first battery cell by means of a first current. In this case, a first electrical resistance value of the rapid-discharge unit is selected in such a way that the first current causes the electrochemical part to heat up when it flows through the rapid-discharge unit and the first battery cell in such a way that the at least one separator reaches the first temperature.

In the battery system described above, when the first resistance value is selected appropriately, a current value of the first current becomes so great that the first current leads to intense heating of the entire electrochemical part of the first battery cell. This intense heating further leads to the at least one separator reaching the first temperature and thereby becoming at least partly impermeable to the ions that can be generated in the electrochemical part. This means that, upon reaching the first temperature, the at least one separator can allow only a small portion of said ions or can no longer allow any ions at all to pass through. Consequently, charge carrier transport can no longer take place or only very little charge carrier transport can take place within the electrochemical part. Charge carriers are understood here to mean the ions mentioned.

In a case in which the at least one separator becomes partly impermeable to the aforementioned ions, a partial surface of an entire surface of the at least one separator becomes impermeable to the aforementioned ions. In this case, the separator and consequently the first battery cell as well are partly electrically deactivated. As a result thereof, a maximum current valve of the first current is greatly limited, such that the first battery cell can no longer cause hazards or can cause only very minor hazards.

In a case in which the at least one separator becomes fully impermeable to the aforementioned ions, the entire surface of the at least one separator becomes impermeable to the aforementioned ions. In this case, the at least one separator and consequently the first battery cell as well are fully electrically deactivated. After full deactivation of the at least one separator and consequently the first battery cell as well, the first current has a current value close to 0 A and a voltage applied between the two battery cell terminals of the first battery cell has a voltage value close to 0 V. As a result thereof, the first battery cell can no longer deliver an electric current via its two battery cell terminals to an electrical circuit located outside of the first battery cell. This happens even though an amount of energy stored electrochemically in the electrochemical part of the first battery cell at the beginning of the deactivation of the at least one separator is still present in the electrochemical part. Likewise, a short circuit inside the first battery cell, which occurs, for example, between the electrodes of the first battery cell, can also no longer lead to a potentially dangerous discharge current inside the first battery cell. Consequently, the energy stored electrochemically in the electrochemical part of the first battery cell at the beginning of the electrical deactivation of the at least one separator continues to remain in the electrochemical part and can no longer be withdrawn by means of a discharge current.

After deactivation of the first battery cell as described above, a hazard can no longer arise due to a current flowing over a circuit located outside of the first battery cell. It should be taken into account here that a current of this kind can lead to the formation of electric arcs or, in the presence of a short circuit, to overheating of current conductors and/or the first battery cell as well. Likewise, after deactivation of the first battery cell as described above, a hazard due to damage to the battery cell can no longer arise. It should be taken into account here that mechanical damage to the first battery cell can lead, in particular, to ignition of the first battery cell.

In a battery system described above, the electrochemical part of the first battery cell is preferably designed in the form of at least one jelly roll or an electrode stack.

In a battery system described above, the first current can preferably have a current value 10 to 30 times greater than a current value assumed by a discharge current of the first battery cell during normal operation of the first battery cell.

In a battery system described above, the at least one separator preferably reaches the first temperature immediately after a first period beginning with connection of the rapid-discharge unit has elapsed. The first period preferably has a duration of several seconds, in particular 20 s.

According to a first preferred development of the invention, the first resistance value is further selected in such a way that the heating of the electrochemical part caused by the first current when it flows through the first battery cell and the rapid-discharge unit does not trigger thermal runaway in the first battery cell. Thermal runaway in the first battery cell can be triggered, for example, by complete melting or by withdrawal of the at least one separator and therefore its complete ineffectiveness.

In a battery system described above, the battery cells can preferably be arranged in a series circuit. In such a case, deactivation of the first battery cell described above leads to interruption of an entire circuit running over the battery cells. When said circuit is interrupted, a contact voltage can no longer arise as a result of the battery having the battery cells, such that a hazard caused by the battery can no longer arise due to contact current.

According to a second preferred development of the invention, the control unit is designed to connect the rapid-discharge unit between the two battery cell terminals of the first battery cell in the presence of a fault state of the first battery cell and/or the battery system and/or the vehicle. The second development can be combined with the first development and/or the configurations thereof. This achieves a situation in which deactivation of the first battery cell described above can take place not only when a fault state of the first battery cell is present but also when a fault state of the battery system and/or the vehicle is present.

According to a third preferred development of the invention, the control unit is designed to communicate with a first and/or second sensor unit of the battery system and/or with a monitoring unit of the battery system and/or with at least one control device of the battery system. Here, the first sensor unit is designed to detect at least one first physical variable with respect to at least one state of the first battery cell, in particular with respect to an operating and/or movement state of the first battery cell. As an alternative or in addition, the second sensor unit is designed to detect at least one second physical variable with respect to at least one state of the battery system, in particular with respect to an operating and/or movement state of the battery system. As an alternative or in addition, the monitoring unit is designed to identify the presence of the fault state of the battery system and to generate at least one warning signal or pieces of warning information in the presence of the fault state of the battery system. As an alternative or in addition, the at least one control device is designed to generate in each case pieces of control information and/or control signals for the purpose of controlling at least one component of the battery system. Here, the at least one control device is designed to generate the pieces of control information and/or the control signals, in particular on the basis of an evaluation of sensor signals of the first and/or the second sensor unit. In this case, the pieces of control information preferably comprise pieces of information that are ascertained by means of the at least one control device during at least one signal processing operation performed thereby. The third preferred development can be combined with one or more of the preferred developments described above and/or the configurations thereof.

In a battery system according to the third preferred development, the control unit can preferably communicate with one of each of the components of the respective battery system described immediately above via a direct connection or via a communication interface, in particular via a CAN interface.

According to a fourth preferred development of the invention, the control unit is designed to identify the presence of the fault state of the first battery cell on the basis of an evaluation of sensor signals of the first sensor unit. As an alternative or in addition, the control unit is designed to identify the presence of the fault state of the battery system on the basis of an evaluation of sensor signals of the second sensor unit. As an alternative or in addition, the control unit is designed to identify the presence of the fault state of the battery system in the presence of the at least one warning signal and/or on the basis of an evaluation of the pieces of warning information. As an alternative or in addition, the control unit is designed to identify the presence of the fault state of the battery system on the basis of an evaluation of at least one of the control signals and/or at least one of the pieces of control information. The fourth preferred development can be combined with one or more of the preferred developments described above and/or the configurations thereof.

What is advantageous in a battery system according to the fourth preferred development is that the control unit can utilize such signals and pieces of information generated for other purposes and consequently already present in the battery system in order to identify the fault state of the battery system and consequently in order to initiate deactivation of the first battery cell described above as well. What is furthermore advantageous in a battery system according to the fourth preferred development is that the control unit can initiate deactivation of the first battery cell described above not only during utilization of the respective battery system in the vehicle. Instead, the control unit can also initiate deactivation of the first battery cell described above during another part of a life cycle of the first battery cell or of the respective battery system, such as during transport or assembly of the first battery cell or of the respective battery system, for example.

According to a fifth preferred development of the invention, the first and/or the second sensor unit each comprise a voltage sensor and/or a current sensor and/or an acceleration sensor. The fifth preferred development can be combined with one or more of the preferred developments described above and/or the configurations thereof.

According to a sixth preferred development of the invention, the monitoring unit is designed to identify an improper use of the battery system on the basis of an evaluation of sensor signals of the first and/or the second sensor unit. As an alternative or in addition, the monitoring unit is designed to identify an inappropriate opening of the battery system. As an alternative or in addition, the monitoring unit is designed to identify a manipulation of a software and/or hardware component present in the battery system and designed for the purpose of controlling the battery system. In this case, the monitoring unit is further designed to determine the presence of the fault state of the battery system by identifying the improper use and/or the inappropriate opening and/or the manipulation. The sixth preferred development can be combined with one or more of the preferred developments described above and/or the configurations thereof.

In a battery system according to the sixth embodiment of the invention, the control unit can be designed to identify a presence of at least one impermissible value of at least one operating parameter of the respective battery system on the basis of the evaluation of the sensor signals of the second sensor unit. The control unit can be further designed to identify the improper use of the respective battery system in the presence of the at least one impermissible value. Such an impermissible value can be, for example, an extremely high current value of a discharge current of the respective battery system or an impermissible polarity of a voltage applied to the respective battery system or an impermissible voltage value of the voltage applied to the respective battery system.

According to a seventh preferred development of the invention, the monitoring unit comprises an electrical connection and/or a communication interface. Here, the monitoring unit is designed to identify a presence of the inappropriate opening of the battery system when the electrical connection is interrupted. As an alternative or in addition, the monitoring unit is designed to identify an opening of the battery system. Here, the monitoring unit is further designed to classify the identified opening as inappropriate opening of the battery system when, before the identified opening of the battery system, pieces of control information, which are to be transmitted to the communication interface of the monitoring unit before an appropriate opening of the battery system, are absent. The seventh preferred development can be combined with one or more of the preferred developments described above and/or the configurations thereof.

According to an eighth preferred development of the invention, the control unit is designed to communicate with a third sensor unit of the vehicle and/or with a monitoring apparatus of the vehicle and/or with at least one control element of the vehicle and/or with a communication interface of the vehicle. Here, the third sensor unit is designed to detect at least one third physical variable with respect to at least one state of the vehicle, in particular with respect to a movement and/or flooding state of the vehicle. As an alternative or in addition, the monitoring apparatus is designed to identify the presence of the fault state of the vehicle on the basis of an evaluation of sensor signals of the third sensor unit and to ascertain pieces of information about the fault state of the vehicle. As an alternative or in addition, the at least one control element is designed to generate at least one trigger signal for the purpose of triggering at least one safety function of the vehicle in the presence of the fault state of the vehicle. As an alternative or in addition, the communication interface of the vehicle is designed to emit at least one further trigger signal in the presence of the fault state of the vehicle. The eighth preferred development can be combined with one or more of the preferred developments described above and/or the configurations thereof.

In a battery system according to the eighth preferred development, the at least one trigger signal can comprise a trigger signal for an airbag ignition operation of an airbag of the vehicle.

According to a ninth preferred development of the invention, the control unit is designed to identify the presence of the fault state of the vehicle on the basis of an evaluation of sensor signals of the third sensor unit. As an alternative or in addition, the control unit is designed to identify the presence of the fault state of the vehicle on the basis of an evaluation of at least one of the pieces of information about the fault state of the vehicle. As an alternative or in addition, the control unit is designed to identify the presence of the fault state of the vehicle in the presence of the at least one trigger signal. As an alternative or in addition, the control unit is designed to identify the presence of the fault state of the vehicle upon reception of the at least one further trigger signal. The ninth preferred development can be combined with one or more of the preferred developments described above and/or the configurations thereof.

What is advantageous in a battery system according to the ninth preferred development is that the control unit can utilize such signals and pieces of information generated for other purposes and consequently already present in the vehicle in order to identify the fault state of the vehicle and consequently in order to initiate deactivation of the first battery cell described above as well.

In a battery system according to the ninth preferred development, deactivation of the first battery cell described above is preferably triggered remotely via the communication interface of the vehicle.

According to a tenth preferred development of the invention, the third sensor unit comprises an acceleration sensor and/or a flooding sensor.

In a battery system described above, the fault state of the vehicle can arise as a result of an accident of the vehicle and/or as a result of a natural disaster that affects the vehicle, such as flooding of the vehicle, for example. In this case, the pieces of information about the fault state of the vehicle preferably comprise pieces of information about the accident and/or pieces of information about a flooding state of the vehicle.

A further aspect of the invention relates to a method for transferring the first battery cell of a battery system described above to a safe state. Here, the method comprises a step of identifying a presence of a fault state of the first battery cell and/or the battery system and/or the vehicle. The method further comprises a step of electrically connecting the rapid-discharge unit of the first battery cell between the two battery cell terminals of the first battery cell.

In a battery system described above, at least one further battery cell or each further one of the battery cells of the battery can be designed in the same way in which the first battery cell is designed. In such a case, the control unit has the same functionality with respect to one of each of the at least one further battery cell and the first battery cell or with respect to each further battery cell of the battery and the first battery cell. Furthermore, each of the at least one further battery cell or each further battery cell of the battery can be controlled in the same way in which the first battery cell can be controlled.

In a battery system described above, in which each further battery cell of the battery and the first battery cell are designed in the same way, the respective battery system can no longer cause hazards after deactivation of each battery cell of the battery described above. In such a case, the respective battery system can no longer cause a hazard, in particular, after all poles thereof have been disconnected.

A battery system described above can also be used in a stationary energy store, a tool or in another means of movement, such as a two-wheeled vehicle or an aircraft, for example. What would be advantageous here would be for the control unit to be able to utilize such signals and pieces of information generated for other purposes and consequently already present in the tool or in the means of movement in order to initiate deactivation of the first battery cell or each battery cell of the battery designed in the same way as the first battery cell described above.

### BRIEF DESCRIPTION OF THE DRAWINGS

Exemplary embodiments of the invention are described in detail below with reference to the appended drawings. The same reference signs are in each case used for identical components and parameters. Each component and each parameter are respectively introduced once and treated as already being known if repeated, irrespective of the sign or exemplary embodiment to which a respectively corresponding part of the description in which the component in question or the parameter in question is repeated relates. In the drawings:

FIG. 1 shows an arrangement with a battery system, illustrated in a highly schematized manner and designed according to a first embodiment of the invention, for a vehicle and a part of an electronics system of the vehicle, illustrated in a highly schematized manner, wherein the battery system has a first battery cell comprising a rapid-discharge unit that can be connected between two battery cell terminals, which can be contact-connected from inside and/or outside of the first battery cell, and

FIG. 2 shows a time-dependent profile of a first current flowing through the first battery cell and the rapid-discharge unit and a time-dependent profile of a voltage applied between the two battery cell terminals of the first battery cell when the first current flows through the first battery cell and the rapid-discharge unit.

### DETAILED DESCRIPTION

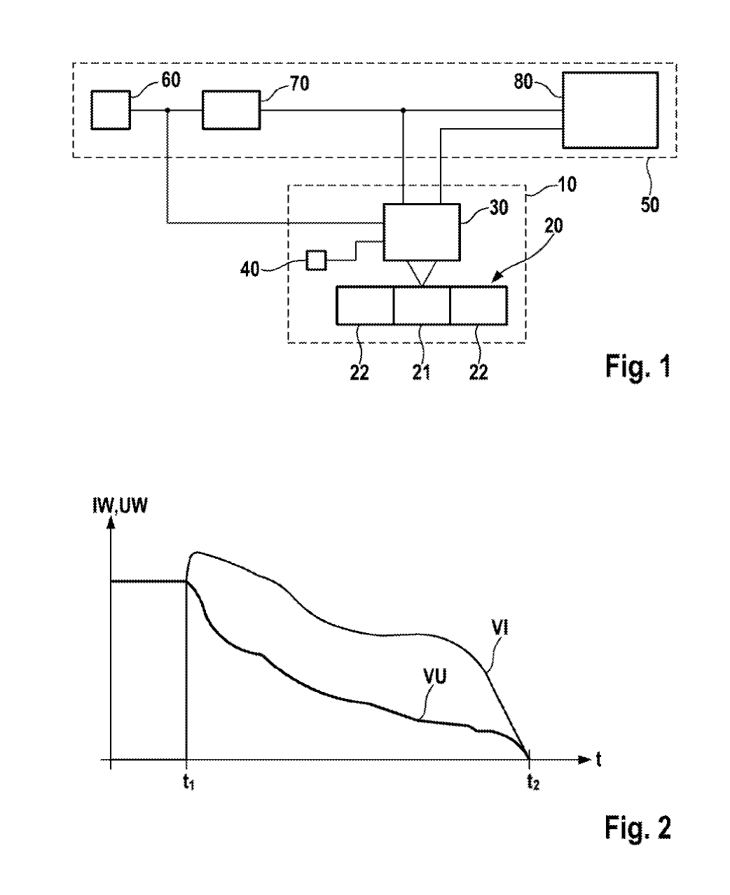

FIG. 1 shows an arrangement with a battery system 10, illustrated in a highly schematized manner and designed according to a first embodiment of the invention, for a vehicle. The battery system 10 comprises a battery 20 comprising a plurality of battery cells 21, 22 arranged in a series circuit. The battery cells 21, 22 comprise a first battery cell 21 and a plurality of further battery cells 22.

The first battery cell 21 comprises an electrochemical part (not illustrated separately) designed, for example, in the form of at least one jelly roll and comprising a plurality of electrodes and at least one separator.

The electrodes of the first battery cell 21 can be designed in the form of a planar arrangement comprising a plurality of layers of carrier materials and chemical substances. The electrodes can further be designed in the form of coated metal films and are isolated from one another by the at least one separator.

To form the at least one jelly roll respectively, for example, two of the electrodes and one of the at least one separator are arranged one above the other and then wound in the shape of a round or flat reel. The at least one jelly roll can be arranged in a housing, for example made of metal, of the first battery cell 21. In such a case, the first battery cell 21 can be of prism-shaped design.

The at least one separator can be designed in each case in the form of an electrically insulating film structure that is permeable to ions that can be generated in the electrochemical part of the first battery cell 21. In this case, upon reaching a first temperature, the at least one separator becomes at least partly impermeable to the ions mentioned.

The first battery cell 21 further comprises a rapid-discharge unit (not illustrated separately), which has, for example, at least one specific electrical resistance. The rapid-discharge unit can be electrically connected, by means of a control unit 30 of the battery system 10, between two battery cell terminals (not illustrated separately) of the first battery cell 21, which battery cell terminals can be contact-connected from inside and/or outside of the first battery cell 21. The rapid-discharge unit is designed to discharge the first battery cell 21 by means of a first current. Here, a first resistance value of the rapid-discharge unit is selected in such a way that the first current causes the electrochemical part of the first battery cell 21 to heat up when it flows through the rapid-discharge unit and the first battery cell 21 in such a way that the at least one separator reaches the first temperature.

When the first resistance value is selected appropriately, a current value of the first current becomes so great that the first current leads to intense heating of the entire electrochemical part of the first battery cell 21. This intense heating leads to the at least one separator reaching its first temperature and thereby becoming at least partly impermeable to the ions mentioned. This means that, upon reaching the first temperature, the at least one separator can allow only a small portion of said ions or can no longer allow any ions at all to pass through. Consequently, charge transport can no longer take place or only very little charge carrier transport can take place within the electrochemical part of the first battery cell 21. Charge carriers are understood here to mean the ions mentioned.

In a case in which the at least one separator becomes partly impermeable to the ions mentioned, the first battery cell 21 is partly electrically deactivated. In such a case, a maximum current value of the first current is furthermore greatly limited, such that the first battery cell 21 can no longer cause a hazard or can cause only a very minor hazard.

In a case in which the at least one separator becomes fully impermeable to the ions mentioned, the first battery cell 21 is fully electrically deactivated. After full deactivation of the first battery cell 21, the first current has a current value close to 0 A and a voltage applied between the two battery cell terminals of the first battery cell 21 has a voltage value close to 0 V. In such a case, the first battery cell 21 can no longer cause hazards.

The first resistance value is further selected in such a way that the heating of the electrochemical part generated by the first current when it flows through the first battery cell 21 and the rapid-discharge unit does not trigger thermal runaway in the first battery cell 21.

In this case, the control unit 30 is designed to communicate directly with a first sensor unit (not illustrated separately) arranged in or at the first battery cell 21 and with a second sensor unit 40 arranged in or at the battery system 10. To this end, the control unit 30 is connected to the first and the second sensor unit 40 in each case directly or via at least one communication interface.

The first sensor unit comprises at least one first sensor and is designed to detect at least one first physical variable with respect to at least one state of the first battery cell 21. The at least one first sensor comprises, for example, a voltage sensor and/or a current sensor and/or an acceleration sensor. The control unit 30 is designed to identify a presence of a fault state of the first battery cell 21 on the basis of an evaluation of sensor signals of the first sensor unit.

The second sensor unit 40 comprises at least one second sensor (not illustrated separately) and is designed to detect at least one second physical variable with respect to at least one state of the battery system 10. The at least one second sensor comprises, for example, a voltage sensor and/or a current sensor and/or an acceleration sensor. The control unit 30 is designed to identify a presence of a fault state of the battery system 10 on the basis of an evaluation of sensor signals of the second sensor unit 40.

The arrangement illustrated in FIG. 1 further comprises a part 50 of an electronics system of the vehicle, wherein said part illustrated in FIG. 1 comprises a third sensor unit 60, a monitoring apparatus 70 and a control element 80. Here, the monitoring apparatus 70 is designed to communicate both with the third sensor unit 60 and with the control element 80. To this end, the monitoring apparatus 70 is connected to the third sensor unit 60 and the control element 80 in each case directly or via at least one communication interface.

The control unit 30 is further designed to communicate with the third sensor unit 60, the monitoring apparatus 70 and the control element 80. To this end, the control unit 30 is connected to the third sensor unit 60, the monitoring apparatus 70 and the control element 80 in each case directly or via at least one communication interface.

The third sensor unit 60 comprises at least one third sensor (not illustrated separately) and is designed to detect at least one third physical variable with respect to at least one state of the vehicle. The at least one third sensor comprises, for example, an acceleration sensor and/or a flooding sensor. The control unit 30 is designed to identify a presence of a fault state of the vehicle on the basis of an evaluation of sensor signals of the third sensor unit 60. Here, the fault state of the vehicle can be brought about by an accident or flooding of the vehicle.

The monitoring apparatus 70 is designed to identify the presence of the fault state of the vehicle on the basis of an evaluation of sensor signals of the third sensor unit 60 and to ascertain pieces of information about the fault state of the vehicle. These pieces of information can comprise pieces of information about an accident of the vehicle and/or about a flooding state of the vehicle. The control unit 30 is designed to identify the presence of the fault state of the vehicle on the basis of an evaluation of at least one of the pieces of information about the fault state of the vehicle.

The control element 80 is designed to generate at least one trigger signal for the purpose of triggering a safety function of the vehicle, for example the airbag ignition operation of an airbag of the vehicle, in the presence of the fault state of the vehicle. The control unit 30 is designed to identify the presence of the fault state of the vehicle in the presence of the at least one trigger signal.

The control unit 30 is furthermore designed to connect the rapid-discharge unit in each case between the two battery cell terminals of the first battery cell 21 in the presence of the fault state of the first battery cell 21, the battery system 10 and the vehicle and to introduce deactivation of the first battery cell 21 described above as a result.

In the battery system described above, one each of the further battery cells 22 can be designed in the same way in which the first battery cell 21 is designed. Here, the control unit 30 has the same functionality with respect to the first battery cell 21 and each further battery cell 22. A battery system described above can also have a plurality of control units 30.

FIG. 2 shows a profile VI of a first current flowing though the rapid-discharge unit as a function of the time t.

A first time t1 and a second time t2 are plotted in FIG. 2. In this case, the rapid-discharge unit is connected between the two battery cell terminals of the first battery cell 21 by the control unit 30 at the first time t1. Full deactivation of the first battery cell 21 described further above is achieved at the second time t2.

FIG. 2 further shows, between the first and the second time t1, t2, an exemplary profile VU of a voltage applied between the two battery cell terminals of the first battery cell 21 as a function of the time t. An axis denoted in FIG. 2 by IW, UW indicates current values and voltage values.

At the second time t2, the first current has a current value of close to 0 A and the voltage applied between the two battery cell terminals of the first battery cell 21 has a voltage value of close to 0 V.

Besides the written disclosure above, reference is hereby additionally made to the depiction in FIGS. 1 and 2 for further disclosure of the invention.

1. A battery system (10) for a vehicle and/or a stationary energy store, the battery system comprising a battery (20), which has at least first and second battery cells (21, 22), and a control unit (30), wherein the first battery cell comprises an electrochemical part comprising a plurality of electrodes and at least one separator, wherein, upon reaching a first temperature, the at least one separator becomes at least partly impermeable to ions that can be generated in the electrochemical part, characterized in that the first battery cell (21) comprises a rapid-discharge unit, wherein the rapid-discharge unit is configured to be electrically connected, by means of the control unit (30), between two battery cell terminals of the first battery cell (21), which battery cell terminals can be contact-connected from inside and/or outside of the first battery cell (21), and is configured to discharge the first battery cell (21) by means of a first current, wherein a first resistance value of the rapid-discharge unit is selected such that the first current causes the electrochemical part to heat up when the first current flows through the rapid-discharge unit and the first battery cell (21) such that the at least one separator reaches the first temperature.

2. The battery system (10) as claimed in claim 1, characterized in that the first resistance value is further selected such that heating of the electrochemical part generated by the first current when the first current flows through the first battery cell (21) and the rapid-discharge unit does not trigger thermal runaway in the first battery cell (21).

3. The battery system (10) as claimed in claim 1, characterized in that the control unit (30) is configured to connect the rapid-discharge unit between the two battery cell terminals in the presence of a fault state of the first battery cell (21) and/or the battery system (10) and/or the vehicle.

4. The battery system (10) as claimed in claim 3, characterized in that the control unit (30) is configured to communicate with a first and/or second sensor unit (40) of the battery system (10) and/or with a monitoring unit of the battery system (10) and/or with at least one control device of the battery system (10), wherein the first sensor unit is configured to detect at least one first physical variable with respect to at least one state of the first battery cell (21), and/or wherein the second sensor unit (40) is configured to detect at least one second physical variable with respect to at least one state of the battery system (10), and/or wherein the monitoring unit is configured to identify the presence of the fault state of the battery system (10) and to generate at least one warning signal or pieces of warning information in the presence of the fault state of the battery system (10) and/or wherein the at least one control device is configured to generate in each case pieces of control information and/or control signals for the purpose of controlling at least one component of the battery system (10).

5. The battery system (10) as claimed in claim 4, characterized in that the control unit (30) is configured to identify the presence of the fault state of the first battery cell (21) on the basis of an evaluation of sensor signals of the first sensor unit and/or to identify the presence of the fault state of the battery system (10) on the basis of an evaluation of sensor signals of the second sensor unit (40) and/or in the presence of the at least one warning signal and/or on the basis of an evaluation of the pieces of warning information and/or on the basis of an evaluation of at least one of the control signals and/or at least one of the pieces of control information.

6. The battery system (10) as claimed in claim 4, characterized in that the first and/or the second sensor unit (40) each comprise a voltage sensor and/or a current sensor and/or an acceleration sensor.

7. The battery system (10) as claimed in claim 4, characterized in that the monitoring unit is configured to identify an improper use of the battery system (10) and/or an inappropriate opening of the battery system (10) and/or a manipulation of a software and/or hardware component present in the battery system on the basis of an evaluation of sensor signals of the first and/or the second sensor unit and to determine the presence of the fault state of the battery system (10) by identifying the improper use and/or the inappropriate opening and/or the manipulation.

8. The battery system (10) as claimed in claim 7, characterized in that the monitoring unit comprises an electrical connection and/or a communication interface, wherein the monitoring unit is configured to identify a presence of the inappropriate opening of the battery system (10) when the electrical connection is interrupted and/or wherein the monitoring unit is configured to identify an opening of the battery system (10) and to classify it as inappropriate opening of the battery system (10) when, before the identified opening of the battery system (10), pieces of control information, which are to be transmitted to the communication interface of the monitoring unit before an appropriate opening of the battery system (10), are absent.

9. The battery system (10) as claimed in claim 3, characterized in that the control unit (30) is configured to communicate with a third sensor unit (60) of the vehicle and/or with a monitoring apparatus (70) of the vehicle and/or with at least one control element (80) of the vehicle and/or with a communication interface of the vehicle, wherein the third sensor unit (60) is configured to detect at least one third physical variable with respect to at least one state of the vehicle, and/or wherein the monitoring apparatus (70) is configured to identify the presence of the fault state of the vehicle on the basis of an evaluation of sensor signals of the third sensor unit (60) and to ascertain pieces of information about the fault state of the vehicle, and/or wherein the at least one control element (80) is configured to generate at least one trigger signal for the purpose of triggering at least one safety function of the vehicle in the presence of the fault state of the vehicle, and/or wherein the communication interface of the vehicle is configured to emit at least one further trigger signal in the presence of the fault state of the vehicle.

10. The battery system (10) as claimed in claim 9, characterized in that the control unit (30) is configured to identify the presence of the fault state of the vehicle on the basis of an evaluation of sensor signals of the third sensor unit (60) and/or on the basis of an evaluation of at least one of the pieces of information about the fault state of the vehicle and/or in the presence of the at least one trigger signal and/or upon reception of the at least one further trigger signal.

11. The battery system (10) as claimed in claim 9, characterized in that the third sensor unit (60) comprises an acceleration sensor and/or a flooding sensor.

12. A method for transferring a first of a plurality of battery cells (21, 22) of a battery (20) of a battery system (10) for a vehicle to a safe state, wherein the battery system (10) is configured as claimed in claim 1, wherein the method comprises the following steps:
identifying a presence of a fault state of the first battery cell (21) and/or the battery system (10) and/or the vehicle, and
electrically connecting the rapid-discharge unit of the first battery cell (21) between the two battery cell terminals of the first battery cell (21).

13. The battery system (10) as claimed in claim 3, characterized in that the control unit (30) is configured to communicate with a first sensor unit (40) of the battery system (10), wherein the first sensor unit is configured to detect at least one first physical variable with respect to at least one state of the first battery cell (21).

14. The battery system (10) as claimed in claim 3, characterized in that the control unit (30) is configured to communicate with a second sensor unit (40) of the battery system (10), wherein the second sensor unit (40) is configured to detect at least one second physical variable with respect to at least one state of the battery system (10).

15. The battery system (10) as claimed in claim 3, characterized in that the control unit (30) is configured to communicate with a monitoring unit of the battery system (10), wherein the monitoring unit is configured to identify the presence of the fault state of the battery system (10) and to generate at least one warning signal or pieces of warning information in the presence of the fault state of the battery system (10).

16. The battery system (10) as claimed in claim 3, characterized in that the control unit (30) is configured to communicate with at least one control device of the battery system (10), wherein the at least one control device is configured to generate in each case pieces of control information and/or control signals for the purpose of controlling at least one component of the battery system (10).

17. The battery system (10) as claimed in claim 3, characterized in that the control unit (30) is configured to communicate with a first sensor unit (40) of the battery system (10), wherein the first sensor unit is configured to detect at least one first physical variable with respect to an operating and/or movement state of the first battery cell (21).

18. The battery system (10) as claimed in claim 3, characterized in that the control unit (30) is configured to communicate with a second sensor unit (40) of the battery system (10), wherein the second sensor unit (40) is configured to detect at least one second physical variable with respect to an operating and/or movement state of the battery system (10).

19. The battery system (10) as claimed in claim 3, characterized in that the control unit (30) is configured to communicate with at least one control device of the battery system (10), wherein the at least one control device is configured to generate in each case pieces of control information and/or control signals for the purpose of controlling at least one component of the battery system (10) on the basis of an evaluation of sensor signals of the first and/or the second sensor unit (40).

20. The battery system (10) as claimed in claim 3, characterized in that the control unit (30) is configured to communicate with a third sensor unit (60) of the vehicle and/or with a monitoring apparatus (70) of the vehicle and/or with at least one control element (80) of the vehicle and/or with a communication interface of the vehicle, wherein the third sensor unit (60) is configured to detect at least one third physical variable with respect to a movement and/or flooding state of the vehicle, and/or wherein the monitoring apparatus (70) is configured to identify the presence of the fault state of the vehicle on the basis of an evaluation of sensor signals of the third sensor unit (60) and to ascertain pieces of information about the fault state of the vehicle, and/or wherein the at least one control element (80) is configured to generate at least one trigger signal for the purpose of triggering at least one safety function of the vehicle in the presence of the fault state of the vehicle, and/or wherein the communication interface of the vehicle is configured to emit at least one further trigger signal in the presence of the fault state of the vehicle.
